(19) United States
(12) Patent Application Publication
(10) Pub. No.: US 2004/0231363 A1
(43) Pub. Date: Nov. 25, 2004

(54) Method and blow-moulding station for the final blowing of a glass container

(76) Inventors: Norbert Monden, Auetal (DE); Hans-Bernhard Fuhr, Radebeul (DE)

Correspondence Address: Synnestvedt & Lechner, 2600 Aramark Tower, 1101 Market Street, Philadelphia, PA, 19107-2940, US

(21) Appl. No.: 10/488,582

(22) PCT Filed: Aug. 7, 2002
(86) PCT No.: PCT/EP02/08804

(30) Foreign Application Priority Data
Sep. 8, 2001 (DE) 10144112.6

(51) Int. Cl. C03B 9/30

(52) U.S. Cl. 65/77; 65/81; 65/82; 65/229; 65/263; 65/267

(57) ABSTRACT

A parison (12) is subjected to final blowing in a blow-mold (2) of a blow-molding station (1) to produce a finished glass container (19). The blow-mold (2) comprises blow-mold halves (3, 4) and a block mold (18) which is not divided longitudinally and which is encompassed by the blow-mold halves (3, 4) when the blow-mold (2) is closed. Compressed air (15) can be introduced by means of a blowing head (13) into the interior of the parison (12), until the finished glass container (19) has achieved its final form. In order to remove the glass container (19) from the blow-mold (2), it is grasped by its mouth (11) by means of a takeout mechanism. The blow-mold halves (3, 4) are then opened and the block mold (18) is moved downwards until it reaches a removal position.

The invention relates to a method according to the preamble of claim 1 or 2 and to a blow-molding station according to the preamble of claim 5 or 6.

In the case of a known blow-molding station according to the preamble of claim 1 or 5 (U.S. Pat. No. 1,911,119 A, FIG. 22), the blow-mold halves extend to beyond the base of the finished glass container and embrace a separate blow-mold base. As a consequence, on the opposite-lying longitudinal part joints of the blow-mold halves complementary longitudinal seams are formed on the finished glass container. These longitudinal seams become larger and more problematic as the wear on the blow-mold halves increases.

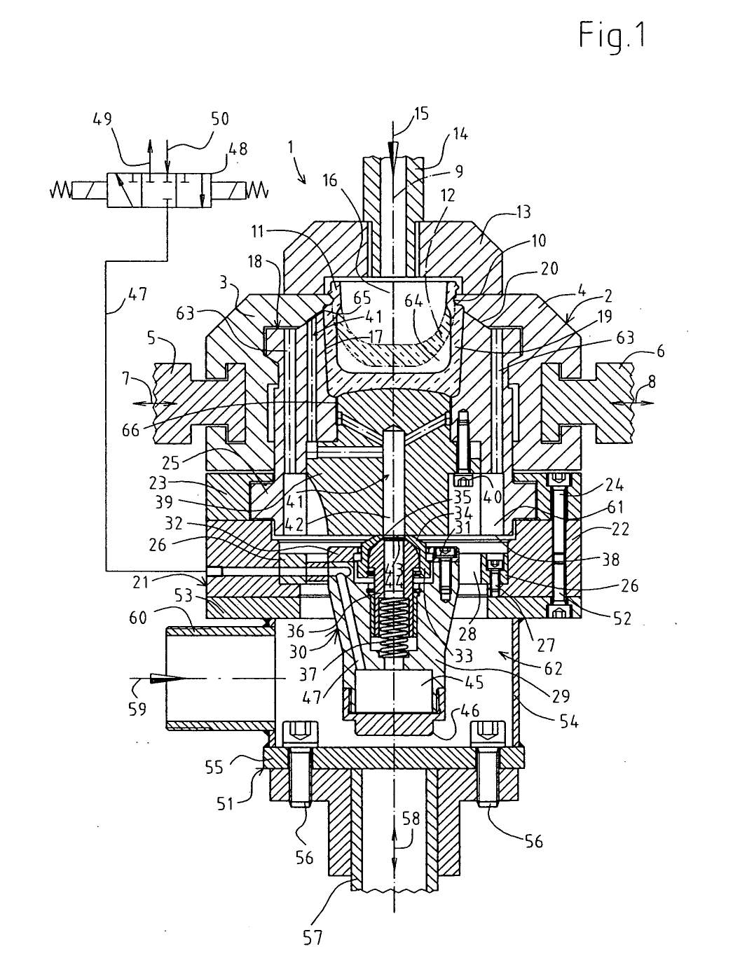

In the case of a known blow-molding station in accordance with the preamble of claim 2 or 6 (DE patent document 1 704 112 by the Applicant, S2 in FIG. 1), blow-mold halves engage at the top over a closed, longitudinally-divided neck ring with the parison appended thereto and engage at the bottom over a blow-mold base. In this case, it is also not possible to obviate longitudinal seams on the finished glass container.

From EP 0 102 001 B1, FIG. 1, by the Applicant, it is known per se in a parison-molding station of a press-and-blow glassware forming machine having parison mold middle piece halves to engage at the top over a closed, longitudinally-divided neck ring and at the bottom over a block mold which is not divided longitudinally. In order to provide or remove an additional volume of the block mold recess, a piston can be displaced cyclically in a reciprocating manner in a coaxial base recess of the block mold. The mold recess can be optionally connected to a vacuum line or a compressed air line by way of a channel system in the block mold and in the piston and by way of a directional control valve.

From DE 23 24 953 B2, FIGS. 3 and 4, by the Applicant it is known per se for the purpose of turn-molding a glass container to drive the guide ring, which is not divided and is held by means of a longitudinally-divided neck ring, in a rotating manner during final blowing of the glass container. For this purpose, the guide ring has axis-parallel pins by means of which radial entrainer pins of the blowing head, which can be driven in a rotating manner, can be moved in drive-contact. The guide ring transmits (FIGS. 11 and 12) its rotational movement to the mouth of the glass container and consequently to the glass container as a whole. As a result, during blow-molding the glass container rotates on the one hand relative to the closed neck ring and on the other hand relative to an axially movable block mold which is not divided. The neck ring and the block mold are axially aligned with each other and comprise therebetween a gap. This blow mold is only suitable and provided for turn-molding processes.

DE 197 13 281 A1 discloses as being known per se a blowing head which is inverted at a spaced interval on all sides over the mouth of a parison and is placed on to the closed blow-mold.

From JP 57-145037 A it is known per se when blow-molding a glass container to drive the neck ring, which supports the parison, and a central base insert of the blow-mold synchronously in a rotating manner.

From JP 07-276483 A it is known per se to make the blow-mold from a block mold, which is not divided longitudinally, and from a longitudinally-divided base mold. A longitudinally-divided neck ring lies at the top on the block mold. During final blowing, there is no relative rotation between the glass container and the blow-mold. For the purpose of removing the glass container, the base mold is opened and the glass container is drawn axially out of the block mold.

It is the object of the invention substantially to obviate longitudinal seams on the finished glass container.

With respect to the method, this object is achieved by the features of claim 1 or 2. Within its effective range, the block mold in both cases prevents longitudinal seams from forming on the finished glass container. Therefore, glass containers of this type have a uniform appearance all around. It is advantageous if the body of the glass containers extends in a slightly conical manner towards the mouth. This facilitates removal of the finished glass container from the block mold.

The features of claims 3 render it possible for the parison to be placed quickly against the wall of the mold recess of the block mold during final blowing.

In accordance with claim 4, the procedure of removing the finished glass container from the block mold can be facilitated and enhanced.

With regard to the blow-molding station, the aforementioned object is achieved by the features of claim 5 or 6. Essentially the same advantages are achieved as in claim 1 or 2.

In accordance with claim 7, a 3-port/3-position valve is preferably used as a directional control valve.

The features of claim 8 allow the block mold to be replaced rapidly for maintenance purposes or in the event of wear.

In accordance with claim 9, as the block mold is inserted into the receiving device according to claim 8 the connection between the channel system of the block mold and the channel of the connection device is established automatically. Preferably, an element of the connection device is prestressed in a resilient manner against the base surface of the block mold. Therefore, a sufficiently tight gap seal is provided for the vacuum and compressed air.

The circumferential gaps in accordance with claim 10 and/or 11 allow air to be supplied to and vented from the mold recess in a particularly rapid manner.

The features of claim 12 provide advantages in terms of manufacturing technology for the provision of the second circumferential gap. Moreover, the channel system can be produced more easily in the base insert.

In accordance with claim 13, it is possible to achieve simple and very effective cooling of the block mold.

These and further features and advantages of the invention will be explained in detail hereinunder with reference to the exemplified embodiments illustrated in the drawings, in which

FIG. 1 shows a longitudinal sectional view of a first embodiment of the blow-molding station having blow-mold halves, and

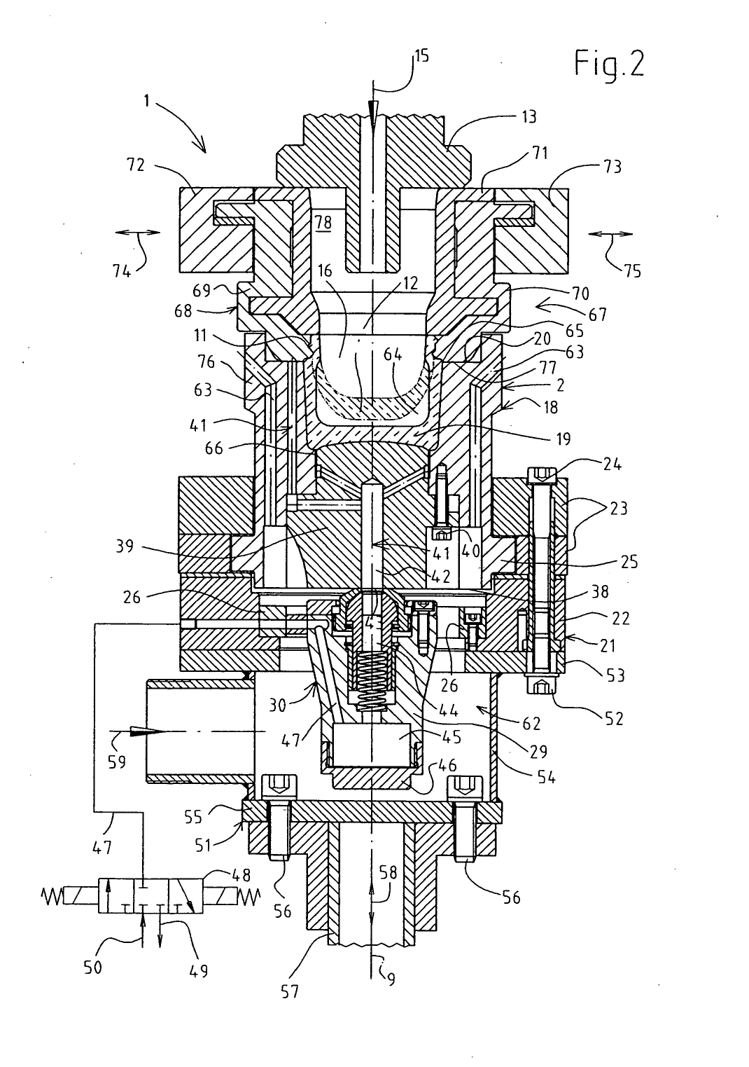

FIG. 2 shows a longitudinal sectional view of a different embodiment of the invention without blow-mold halves.

FIG. 1 illustrates a blow-molding station 1 of a glassware forming machine, e.g. a so-called I.S. (Individual Section) glassware forming machine. One or several blow-molds 2 can be disposed in each blow-molding station 1 for single or multiple molding operation. For the purpose of simplification, FIG. 1 shows only one such blow-mold 2.

The blow-mold 2 comprises blow-mold halves 3 and 4 which are produced by means of longitudinal division. Each blow-mold half 3, 4 is hooked onto a blow-mold holder half 5 and 6 and can be moved thereby in the directions of the double arrows 7 and 8 transversely with respect to a longitudinal axis 9 of the blow-mold 2. This transverse movement can be performed either linearly or by means of tongs on an arc of a circle. In this way, the blow-mold halves 3, 4 can be moved between a closed position as illustrated in FIG. 1 and an open position more remote from the longitudinal axis 9.

In the closed position, the blow-mold halves 3, 4 are only in contact with an axially relatively short annular zone 10 at a mouth 11 of a parison 12. Beforehand, a neck ring [illustrated only in FIG. 2] e.g. by means of an invert mechanism of an I.S. glassware forming machine was used to transport the parison 12 from a parison-molding station to the blow-molding station 1 and by opening the neck ring the parison was transferred to the previously closed blow-mold halves 3, 4 in the manner shown in FIG. 1.

A blowing head 13 is inverted over the mouth 11 and in contact with the closed blow-mold halves 3, 4. Compressed air which passes into the interior of the parison 12 and subjects the parison 12 to final blowing is supplied to the blowing head 13 in a pulsed manner through a connecting piece 14 in the direction of an arrow 15. The wall of the parison becomes increasingly thinner and in a mold recess 16 of the blow-mold 2 it becomes attached on the one hand still further to the blow-mold halves 3, 4 and on the other hand to an internal wall 17 of a block mold 18 which is not divided longitudinally. The end result of this final blowing procedure is illustrated in FIG. 1 by a finished glass container 19.

When the parison mold 2 is closed, the block mold 18 is located in its upper working position. The block mold 18 is encompassed by the blow-mold halves 3, 4. In this state, a free edge 20 of the block mold 18 lies against a complementary counter-surface of the blow-mold halves 3, 4.

Below the blow-mold halves 3, 4, the block mold 18 is held in a receiving device 21. The receiving device 21 comprises an annular lower part 22 to which a cover ring 23, which is L-shaped in cross-section, is screwed by means of screws 24. In this manner, the cover ring 23 accommodates an external flange 25 of the block mold 18. In the interior of the lower part 22, a spoke ring 26 is attached by means of screws 27. The spoke ring 26 comprises several spokes 28 which are distributed over the periphery and which are attached internally to a housing 29 of a connection device 30. A head ring 32 which is attached by screws 31 to the housing 29 serves as an axial stop for an external flange 33 of a sealing cap 34 having a central opening 35. Lying on the inside against the sealing cap 34 is a hemispherical head of a pressure piston 36 which can be displaced axially in the housing 29. Disposed between the pressure piston 36 and the housing 29 is a compression spring 37. The compression spring 37 ensures that the sealing cap 34 always lies with a certain degree of pretensioning against a base surface 38 of the block mold 18.

The block mold 18 comprises a base insert 39 which is attached by screws 40 to the rest of the block mold 18. A channel system 41 is formed in the block mold 18 including its base insert 39. A central collecting channel 42 of the channel system 41 is formed in the base insert 39 and issues with an orifice 43 in the base surface 38 of the block mold 18. The central opening 35 of the sealing cap 34 is aligned with the orifice 43 and with a channel 44 of the connection device 30. The channel 44 issues at the bottom into a chamber 45 of the housing 29, which chamber 29 is closed at the bottom by means of a screw cap 46. The chamber 45 is connected via a line 47 to a 3-port/3-position valve 48 which is connected to a vacuum line 49 and a compressed air line 50.

The receiving device 21 is provided on its underside with a base 51 which comprises a base ring 53 which is screwed to the lower part 22 by screws 52, a cooling housing 54 which is welded to the base ring 53, and a base plate 55 which is welded on to the cooling housing 54. The base plate 55 is screwed to a lifting rod 57 by means of screws 56. The lifting rod 57 can be raised or lowered cyclically in an axial direction by means of a drive [not illustrated] in the directions of the double arrow 58. This lifting movement serves ultimately to raise the block mold 18 to its working position illustrated in FIG. 1 or to lower it to its removal position.

Cooling air is supplied through a connecting piece 60 to the cooling housing 54 in the direction of an arrow 59. The cooling air flows out of the cooling housing 54 upwards past the housing 29 and the spoke ring 26 into an annular chamber 61 of the block mold 18. This path serves to define a cooling air channel 62. Axis-parallel cooling air bores 63 of the block mold 18 are continuously connected to the annular chamber 61.

The cooling air 59 can be switched on constantly but can also be pulsed as required during the operating cycle.

If compressed air 15 passes through the connecting piece 14 into the interior of the parison 12, an annular chamber 64 between the parison 12 and the blow-mold 2 is connected via the channel system 41 and the directional control valve 48 to the vacuum line 49. For this purpose, the channel system 41 comprises a first circumferential gap 65 between free edge 20 of the block mold 18 and the closed blow-mold halves 3, 4. A further component of the channel system 41 is a second circumferential gap 66 on the base of the mold recess 16. The second circumferential gap 66 is defined radially on the inside by means of a base insert 39 of the block mold 18. The air from the annular chamber 64 is in two axial planes of the mold recess 16 and is thus vented very uniformly through the circumferential gaps 65, 66.

In order to remove the finished glass container 19 from the mold, the glass container is initially grasped by its mouth 11 by means of a takeout mechanism which is known per se. The blow-mold halves 3, 4 are then opened and the lifting rod 57 is lowered together with the block mold 18. To assist the release of the glass container 19 from the internal wall 17, compressed air from the compressed air line 50 is introduced, during the lowering procedure, into the channel system 41 by switching over the directional control valve 48. Compressed air also passes in this manner into the annular gaps 65, 66 and ultimately between the glass container 19 and the block mold 18.

In all of the Figures of the drawing, like parts are designated by like reference numerals.

The blow-molding station 1 in accordance with the exemplified embodiment as shown in FIG. 2 is similar to the blow-molding station 1 as shown in FIG. 1 from the block mold 18 downwards. FIG. 2 also illustrates the closed blow-mold 2 wherein on the one hand the parison 12 is illustrated in dot-dash lines and on the other hand the finished glass container 19 is illustrated by unbroken lines. However, as shown in FIG. 2 the blow-mold halves 3, 4 which are illustrated in FIG. 1 are not used. A type of machine allowing this mode of operation is illustrated and described in the DE-patent document 1 704 112 mentioned in the introduction.

In the case of this type of machine, the parison 12 is produced in a parison mold, of which a neck mold 67 is temporarily also a component. The neck mold 67 comprises a longitudinally-divided neck ring 68 with neck ring halves 69 and 70, in which a guide ring 71, which is not divided longitudinally, is held in a manner known per se even when the neck ring 68 is open. The neck ring halves 69, 70 can each be moved in a neck ring holder half 72 and 73 in the directions of double arrows 74 and 75 either linearly or on an arc of a circle between the closed position as illustrated in FIG. 2 and a position which opens the neck ring 68.

Upon formation of the parison 12 in the parison-molding station the parison 12 remains with its mouth 11 in the closed neck mold 67 and is transported with the neck mold 67 from the parison-molding station to the blow-molding station 1. Once it has arrived at this point, the lifting rod 57 is raised together with the block mold 18 up to the upper working position illustrated in FIG. 2. In the working position, an upper edge flange 76 of the block mold 18 engages over a lower end of the neck ring 68 to provide mutual centering. In so doing, the free edge 20 of the block mold 18 lies against a counter surface 77 of the neck ring 68, but with the exception of the radially inner first circumferential gap 65.

The blowing head 13 is then placed on to the guide ring 71 from above in the manner shown in FIG. 2 and compressed air 15 is blown into the interior of the parison 12, until the parison 12 has been blow-molded to form the finished glass container 19. Even during this final blowing process, the circumferential gaps 65, 66, the channel system 41 and the channel 44 are connected to the vacuum line 49 by way of the directional control valve 48.

In order to remove the finished glass container 19 from the blow-mold 2, the directional control valve 48 is switched in such a manner that the compressed air line 50 is now connected to the channel 44, the channel system 41 and to the circumferential gaps 65, 66. The lifting rod 57 is then moved downwards, until the block mold 18 is located in its lower removal position.

In this removal position, an uppermost limit of the block mold 18 is disposed at a spaced interval below the finished glass container 19. Therefore, upon removal of the blowing head 13 from an axial opening 78 of the neck mold 67, the finished glass container 19 on the still closed neck ring 68 can be transported from the blow-molding station 1 to a transfer station [not illustrated]. In the transfer station the neck ring 68 is opened and releases the mouth 11 of the finished glass container 19. The finished glass container 19 is thereby transferred e.g. on to a conveyor belt so as to be conveyed away.

1. Method of final blowing a parison (12) in a blow-mold (2) of a blow-molding station (1) of a glassware forming machine to produce a finished glass container (19), comprising the following steps:
(a) The parison (12) is held by means of a closed, longitudinally-divided neck ring (68) of a neck mold (67) and is transported to the blow-molding station (1),
(b) blow-mold halves (3, 4) of the blow-mold (2) are closed adjacent to the closed neck ring (68) and are brought into form-fitting contact with a mouth (11) of the parison (12),
(c) the neck ring (68) is opened and removed,
(d) a blowing head (13) is inverted over the mouth (11) and in contact with the closed blow-mold halves (3, 4),
(e) compressed air is introduced by means of the blowing head (13) into the interior of the parison (12) and the parison (12) is subjected to final blowing to produce the finished glass container (19) in abutment against the blow-mold (2),
(f) the blowing head (13) is removed, and
(g) the blow-mold halves (3, 4) are opened and the finished glass container (19) is conveyed away,
characterized by the following steps:
(A) Prior to step (b) a block mold (18) which is not divided longitudinally is moved axially from a removal position to a working position (FIG. 1),
(B) in step (b) the blow-mold halves (3, 4) are brought into contact only with one axially short annular zone (10) at the mouth (11) and at least with a free edge (20) of the block mold (18), and
(C) in step (g) the block mold (18) is moved in an axial direction from its working position (FIG. 1) to its removal position for the purpose of removing the finished glass container (19) from the block mold (18).

2. Method of final blowing a parison (12) in a blow-mold (2) of a blow-molding station (1) of a glassware forming machine to produce a finished glass container (19), comprising the following steps:
(a) The parison (12) is held by means of a closed, longitudinally-divided neck ring (68) of a neck mold (67) and is transported to the blow-molding station (1),
(b) the blow-mold (2) is completed with the incorporation of the closed neck mold (67),
(c) a blowing head (13) is placed on to an axial opening (78) of the closed neck mold (67),
(d) compressed air is introduced by means of the blowing head (13) into the interior of the parison (12) and the parison (12) is subjected to final blowing to produce the finished glass container (19) in rotation-free abutment against the blow-mold (2),
(e) the blowing head (13) is removed,
(f) the finished glass container (19) is removed from the blow-mold (2) by opening the blow-mold (2), and
(g) by opening the neck ring (68) the finished glass container (19) is released so as to be conveyed away,
characterized by the following steps:
(A) In step (b) a block mold (18) which is not divided longitudinally is moved axially from a removal position into a working position (FIG. 2) in contact with the closed neck ring (68), wherein an upper edge flange (76) of the block mold (18) engages over a lower end of the neck ring (68), and
(B) in step (f) the block mold (18) is moved in an axial direction from its working position (FIG. 2) to its removal position for the purpose of removing the finished glass container (19) from the block mold (18).

3. Method as claimed in claim 1, characterized in that in step (e) an annular chamber (64) between the parison (12) and the blow-mold (2) is connected via a channel system (41) in the blow-mold (2) and via a directional control valve (48) to a vacuum line (49).

4. Method as claimed in claim 1, characterized in that in step (C) compressed air is blown from a compressed air line (50) between the finished glass container (19) and the blow-mold (2) via a channel system (41) in the blow-mold (2) and via a directional control valve (48).

5. Blow-molding station (1) of a glassware forming machine,
wherein a parison (12) can be subjected to final blowing in a blow-mold (2) of the blow-molding station (1) to produce a finished glass container (19),
wherein the blow-mold is divided longitudinally and comprises blow-mold halves (3, 4),
wherein the blow-mold halves (3, 4) can be moved in a reciprocating manner between an open and a closed position (FIG. 1),
wherein the blow-mold halves (3, 4) in their closed position (FIG. 1) are in form-fitting contact with a mouth (11) of the parison (12),
wherein a blowing head (13) can be inverted over the mouth (11) and in contact with the closed blow-mold halves (3, 4),
wherein compressed air can be introduced by means of the blowing head (13) into the interior of the parison (12) and the parison (12) can be subjected to final blowing to produce the finished glass container (19) in abutment against the blow-mold (2),
and wherein the blow-mold (2) can be opened and the finished glass container (19) can be removed from the blow-mold (2),
characterized in that the blow-mold (2) comprises a block mold (18) which can be moved axially in a reciprocating manner between a removal position and a working position (FIG. 1),
that the closed blow-mold halves (3, 4) are in contact only with one axially short annular zone (10) at the mouth (11) of the parison (12) and of the finished glass container (19) and at least with a free edge (20) of the block mold (18) located in its working position (FIG. 1),
and that on the one side the blow-mold halves (3, 4) can be opened in order to remove the finished glass container (19) from the mold, and on the other side the block mold (18) can be moved from its working position (FIG. 1) to its removal position.

6. Blow-molding station (1) of a glassware forming machine,
wherein a parison (12) can be subjected to final blowing in a blow-mold (2) of the blow-molding station (1) to produce a finished glass container (19),
wherein the parison (12) is held by means of a closed, longitudinally-divided neck ring (68) of a neck mold (67) and can be transported to the blow-molding station (1),
wherein in the blow-molding station (1) the blow-mold (2) can be completed with the incorporation of the closed neck mold (67),
wherein a blowing head (13) can be placed on to an axial opening (78) of the closed neck mold (67),
wherein compressed air can be introduced by means of the blowing head (13) into the interior of the parison (12) and the parison (12) can be subjected to final blowing to produce the finished glass container (19) in rotation-free abutment against the blow-mold (2),
wherein the finished glass container (19) can be removed from the blow-mold (2) by opening the blow-mold (2),
and wherein by opening the neck ring (68) the finished glass container (19) can be released so as to be conveyed away,
characterized in that the blow-mold (2) comprises a block mold (18) which can be moved axially in a reciprocating manner between a removal position and a working position (FIG. 2),
that when the blow-mold (2) is closed a free edge (20) of the block mold (18) is in contact with the closed neck ring (68) and an upper edge flange (76) of the block mold (18) engages over a lower end of the neck ring (68),
and that in order to remove the finished glass container (19) from the blow-mold (2), the block mold (18) can be moved from its working position (FIG. 2) to its removal position.

7. Blow-molding station as claimed in claim 5,
characterized in that a channel system (41) is formed in the block mold (18),
and that on the one hand the channel system (41) is continuously connected to a mold recess (16) of the blow-mold (2) and on the other hand can be optionally connected to a vacuum line (49) or a compressed air line (50) via a directional control valve (48).

8. Blow-molding station as claimed in claim 5,
characterized in that the block mold (18) is held in a releasable manner in an axially movable receiving device (21).

9. Blow-molding station as claimed in claim 8,
characterized in that a collecting channel (42) of the channel system (41) issues with an orifice (43) in a base surface (38) of the block mold (18),
that a connection device (30) can be urged against an edge of the orifice (43),
that the connection device (30) is supported on the receiving device (21),
and that a channel (44) of the connection device (30) is connected on the one hand to the orifice (43) and on the other hand to the directional control valve (48).

10. Blow-molding station as claimed in claim 7,
characterized in that the channel system (41) comprises a first circumferential gap (65) between on the one hand the free edge (20) of the block mold (18) and on the other hand the closed blow-mold halves (3, 4; FIG. 1) or a counter-surface (77) of the closed neck ring (68; FIG. 2).

11. Blow-molding station as claimed in claim 7,
characterised in that the channel system (41) comprises a second circumferential gap (68) on the base of the mold recess (16).

12. Blow-molding station as claimed in claim 11,
characterised in that the second circumferential gap (66) is defined radially on the inside by means of a base insert (39) of the block mold (18).

13. Blow-molding station as claimed in claim 8,
characterised in that a cooling air channel (62) which is connected to a cooling air source (59) is formed in the receiving device (21),
and that axis-parallel cooling air bores (63) of the block mold (18) are continuously connected to the cooling air channel (62).

14. Method as claimed in claim 2,
characterised in that in step (d) an annular chamber (64) between the parison (12) and the blow-mold (2) is connected via a channel system (41) in the blow-mold (2) and via a directional control valve (48) to a vacuum line (49).

15. Method as claimed in 2, characterized in that in step (B) compressed air is blown from a compressed air line (50) between the finished glass container (19) and the blow-mold (2) via a channel system (41) in the blow-mold (2) and via a directional control valve (48).

16. Method as claimed in 3, characterized in that in step (C) compressed air is blown from a compressed air line (50) between the finished glass container (19) and the blow-mold (2) via a channel system (41) in the blow-mold (2) and via a directional control valve (48).

17. Method as claimed in 14, characterized in that in step (B) compressed air is blown from a compressed air line (50) between the finished glass container (19) and the blow-mold (2) via a channel system (41) in the blow-mold (2) and via a directional control valve (48).
